(19) United States
(12) Patent Application Publication
(10) Pub. No.: US 2014/0210702 A1
(43) Pub. Date: Jul. 31, 2014

(54) SYSTEMS AND METHODS FOR PRESENTING MESSAGES BASED ON USER ENGAGEMENT WITH A USER DEVICE

(71) Applicant: UNITED VIDEO PROPERTIES, INC., Santa Clara, CA (US)

(72) Inventors: Brian C. Peterson, Barrington, IL (US); Francis Chan, San Diego, CA (US)

(73) Assignee: UNITED VIDEO PROPERTIES, INC., Santa Clara, CA (US)

(21) Appl. No.: 13/755,178

(22) Filed: Jan. 31, 2013

(51) Int. Cl. G06F 3/01

(52) U.S. Cl. CPC G06F 3/013
USPC 345/156

(57) ABSTRACT

Methods and systems are described herein for presenting messages to a user based on user engagement with a user device. A message is received for presentation to a user on the user device. A value indicating an attentiveness level of the user is generated with the user device. The value indicating the attentiveness level of the user is compared with an attentiveness level threshold value. In response to determining the value indicating the attentiveness level of the user does not exceed the attentiveness level threshold value, presentation of the message is delayed until the value indicating the attentiveness level of the user exceeds the attentiveness level threshold value.

### BACKGROUND

Traditional systems present messages (e.g., SMS messages, critical updates, reminders, etc.) upon receipt of the message or when a predetermined time is reached. For example, reminders may be presented a predetermined amount of time (e.g., 5 minutes) before the start of a program and SMS messages may be presented when they are received by the user device.

However, because presentation of messages on the user device is based on specific times or events (e.g., receipt of the message), users often miss important information contained in the messages or are disturbed by messages that they receive at inconvenient times, which they do not wish to see at that moment. This is due to the fact that the users may not be engaged with the user device or may not desire to be engaged with the user device at or around the time when the messages are presented.

### SUMMARY OF THE DISCLOSURE

Accordingly, methods and systems are described herein for presenting a message to a user based on user engagement with the user device. In particular, presentation of a received message is delayed until an attentiveness level of the user relative to the user device exceeds a threshold value.

In some embodiments, the media application may incorporate, or have access to, a detection module, which may incorporate various content capture devices and/or content recognition applications and algorithms capable of detecting and identifying various types of data that media application may use to compute an attentiveness level associated with a user. For example, the media application may detect the number of individual users and whether or not the individual users are looking at the display device featuring the message. The media application may use data associated with whether or not the users are viewing the user device, as well as additional data (e.g., data associated with whether or not the users are listening to the display device, interacting with the display device, interacting with another device, or interacting with other users, etc.) to compute an attentiveness level of the user.

In some embodiments, a message may be received for presentation to a user on the user device. The message may be an incoming e-mail, SMS message, social network posting, news alert, a reminder for a media asset, an MMS message, a calendar reminder, a news alert, a sporting event alert, a traffic alert, and an alarm, or other communication. A value indicating an attentiveness level of the user may be generated with the user device. The value indicating the attentiveness level of the user may be compared with an attentiveness level threshold value. In some implementations, the threshold value may be dynamically adjusted based on a user profile, set by a user and/or may be predetermined. In response to determining the value indicating the attentiveness level of the user does not exceed the attentiveness level threshold value, presentation of the message may be delayed until the value indicating the attentiveness level of the user exceeds the attentiveness level threshold value. In particular, the received message may be placed in a message queue and retrieved when the value indicating the attentiveness level of the user is determined to exceed the threshold value.

In some implementations, the value indicating the attentiveness level of the user represents at least one of whether or not the user is gazing towards the user device, whether the user is listening to the user device, whether the user is interacting with another user device, and whether the user is interacting with another user. For example, the attentiveness level may be computed based on one or more attentiveness level criteria. The criteria may include indications of whether or not the user is gazing towards the user device, whether the user is listening to the user device, whether the user is interacting with another user device, whether the user is having a conversation with another user, and whether the user is interacting with another user. Each criterion may be evaluated and a value of one or negative one assigned based on the determination associated with the criterion. A total value of the criteria may be computed as the attentiveness level of the user.

In some embodiments, the value indicating an attentiveness level of the user may be computed by receiving data indicative of whether or not the user is engaged in a conversation with another user. In response to determining the user is engaged in a conversation with another user, the value indicating the attentiveness level of the user may be decreased. In addition or alternatively, the value indicating an attentiveness level of the user may be computed by receiving data indicative of whether or not the user is interacting with another user device. In response to determining the user is interacting with the other user device, the value indicating the attentiveness level of the user may be decreased. In addition or alternatively, the value indicating an attentiveness level of the user may be computed by receiving data indicative of whether or not the user is gazing towards the user device. In response to determining the user is gazing towards the user device, the value indicating the attentiveness level of the user may be increased.

In some embodiments, presentation of the message may be delayed by storing the received message in a memory of the user device. The attentiveness level of the user may be monitored to generate an updated value indicating the attentiveness level of the user. The updated value indicating the attentiveness level of the user may be compared with the attentiveness level threshold value. In response to determining the updated value indicating the attentiveness level of the user does not exceed the attentiveness level threshold value, the process of monitoring to generate the updated value and comparing the updated value with the threshold may be repeated. In response to determining the updated value indicating the attentiveness level of the user exceeds the attentiveness level threshold value, the stored received message may be caused to be presented on the user device.

In some embodiments, presentation of the message may be delayed by processing the message to identify an importance level associated with the message. A determination is made as to whether the importance level of the message exceeds an importance level threshold value. In response to determining that the importance level of the message exceeds the importance level threshold value, an audible or visual alert may be triggered, with the user device, for the user to capture the attention of the user with the user device. In some implementations, the triggering of the audible or visual alert may include monitoring the attentiveness level of the user to generate an updated value indicating the attentiveness level of the user. The updated value indicating the attentiveness level of the user may be compared with the attentiveness level threshold value. In response to determining the updated value indicating the attentiveness level of the user does not exceed the attentiveness level threshold value, an audible or visual level associated with the alert may be increased. The process of monitoring to generate the updated value and comparing the updated value may be repeated. In response to determining the updated value indicating the attentiveness level of the user exceeds the attentiveness level threshold value, the received message may be caused to be presented on the user device.

In some embodiments, the message may be processed to identify an importance level associated with the message. The attentiveness level threshold value may be modified based on the importance level associated with the message, such that the attentiveness level threshold value is decreased when the importance level associated with the message is lower than an importance level threshold value.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a viewing area from which a media application may determine an attentiveness level associated with each user in accordance with some embodiments of the disclosure;

FIG. 2 shows another illustrative example of a viewing area from which the media application may determine an attentiveness level associated with each user in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative example of one component of a detection module, which may be accessed by a media application in accordance with some embodiments of the disclosure;

FIG. 6 is an illustrative example of a data structure indicating an attentiveness level of a user in accordance with some embodiments of the disclosure;

FIG. 7 is a flowchart of illustrative steps for delaying presentation of a message based on user attentiveness level in accordance with some embodiments of the disclosure;

FIG. 8 is a flowchart of illustrative steps for determining an attentiveness level of a user in accordance with some embodiments of the disclosure; and

FIG. 9 is a flowchart of illustrative steps for delaying presentation of a message in accordance with some embodiments of the disclosure.

### DETAILED DESCRIPTION

Methods and systems are described herein for a media application capable of receiving a message, determining an attentiveness level of the user, and, in response to determining that the attentiveness level is below a threshold level, delaying presentation of the message until the attentiveness level of the user is above the threshold level value.

Media applications may take various forms depending on their function. Some media applications generate graphical user interface screens (e.g., that enable a user to navigate among, locate and select content), and some media applications may operate without generating graphical user interface screens (e.g., while still issuing instructions related to the transmission of media assets and advertisements).

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices which they traditionally did not use. As referred to herein, the phrase “display device,” “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front-facing screen and a rear-facing screen, multiple front screens, or multiple angled screens. In some embodiments, the user equipment device may have a front-facing camera and/or a rear-facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media applications may be provided as on-line applications (i.e., provided on a web-site), or as stand-alone applications or clients on user equipment devices. Various devices and platforms that may implement media applications are described in more detail below.

As used herein, an “attentiveness level” is a quantitative or qualitative analysis of the level of attention that a user is giving a media asset, including, but not limited to, an advertisement. For example, an attentiveness level may represent a numerical amount or score computed based on one or more types of data describing the user or users currently within a viewing area of a user device with which the media application is associated. In some embodiments, the attentiveness level may be normalized (e.g., in order to represent a number between one and one-hundred). In some embodiments, the attentiveness level may be described as a percentage (e.g., of a user's total amount of attention). In some embodiments, the attentiveness level may be described as a positive (e.g., “attentive”) or negative (e.g., “non-attentive”) designation. The words “engagement,” “engaged,” “attentiveness,” and “attention” may be used interchangeably throughout and should be understood to have the same meaning. In some embodiments, the attentiveness level of a user may be computed before, during, or after a message is received.

The media application may compute an attentiveness level of a user before or after the a message is received, in order to determine whether or not to delay presentation of the message. For example, in some embodiments, when the attentiveness level of the user is below a predetermined threshold, the media application may add the message to a queue. The media application may continue monitoring the attentiveness level of the user. Each additional message that is received while the attentiveness level is below the threshold may be added to the queue. When the media application determines that the attentiveness level exceeds the predetermined threshold, the media application may start presenting the messages stored in the queue in first-in-first-out order or in last-in-first-out order or in any other suitable order (e.g., in order of importance of the messages).

In some embodiments, the attentiveness level may be based on receiving one or more types of data. For example, the attentiveness level may be determined based on data indicating whether or not the user is viewing a display device upon which a media asset is accessed and where the message is to be presented, data indicating whether the user is listening to the user device where the message is to be presented, data indicating whether the user is interacting with the user device where the message is to be presented, data indicating whether the user is interacting with another device (e.g., a second screen device) where the message is not to be presented, data indicating whether the user is interacting with another user (e.g., having a conversation with another user), or any other information that may be used by the media application to influence the attentiveness level that the media application associates with one or more users.

For example, the presence, or amount of, any type of data may influence (e.g., increase, decrease, or maintain) an attentiveness level of a user as determined by the media application. For example, if the media application determines the user is making eye contact with the display device where the message is to be displayed, the media application may increase an attentiveness level associated with the user as eye contact is indicative of a user devoting his/her attention to the display device and hence will see the message when it is presented. Likewise, if the media application determines the user is engaged in a conversation with other users or is interacting with a second screen device (e.g., a smartphone), the media application may decrease an attentiveness level associated with the user as being engaged in a conversation indicating the user is distracted from the user device and hence will miss the message being presented on the user device.

In some embodiments, the media application may determine a composite attentiveness level of several users. As used herein, a “composite attentiveness level” is a level of attentiveness of a plurality of users that represents a statistical analysis (e.g., a mean, median, mode, etc.) of the individual attentiveness level of each user in the plurality of users. For example, in some embodiments, a message may be delayed from being presented when a composite attentiveness level instead of an attentiveness level associated with a single user does not exceed a threshold value. It should be noted, therefore, that any embodiment or description relating to, or using, an attentiveness level associated with a single user may also be applied to composite attentiveness level of several users.

To determine an attentiveness level of a user, in some embodiments, a media application (e.g., in some cases via a detection module incorporated into or accessible by the media application) may use a content recognition module or algorithm to generate data describing the attentiveness of a user. The content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine the attentiveness of a user. For example, the media application may receive data in the form of a video. The video may include a series of frames. For each frame of the video, the media application may use a content recognition module or algorithm to determine the people (including the actions associated with each of the people) in each of the frame or series of frames.

In some embodiments, the content recognition module or algorithm may also include speech recognition techniques, including but not limited to Hidden Markov Models, dynamic time warping, and/or neural networks (as described above) to translate spoken words into text and/or processing audio data. The content recognition module may also combine multiple techniques to determine the attentiveness of a user. For example, a video detection component of the detection module may generate data indicating that two people are within a viewing area of a user device. An audio component of the detection module may generate data indicating that the two people are currently engaged in a conversation about the media assets (e.g., by determining and processing keywords in the conversation). Based on a combination of the data generated by the various detection module components, the media application may compute an attentiveness level for the two people within the viewing area.

In addition, the media application may use multiple types of optical character recognition and/or fuzzy logic, for example, when processing keyword(s) retrieved from data (e.g., textual data, translated audio data, user inputs, etc.) describing the attentiveness of a user (or when cross-referencing various types of data in databases). For example, if the particular data received is textual data, using fuzzy logic, the media application (e.g., via a content recognition module or algorithm incorporated into, or accessible by, the media application) may determine two fields and/or values to be identical even though the substance of the data or value (e.g., two different spellings) is not identical. In some embodiments, the media application may analyze particular received data of a data structure or media asset frame for particular values or text using optical character recognition methods described above in order to determine the attentiveness of a user. The data received could be associated with data describing the attentiveness of the user and/or any other data required for the function of the embodiments described herein. Furthermore, the data could contain values (e.g., the data could be expressed in binary or any other suitable code or programming language).

An attentiveness level threshold value may be predetermined or dynamically updated. As used herein, an “attentiveness level threshold value” refers to an attentiveness level of a user or users that must be met or exceeded in order for a received message to be displayed on a user device. When the attentiveness level of the user or users does not exceed the attentiveness level threshold value, the received message may be stored in a queue and presentation of the message may be delayed until the attentiveness level is determined to exceed the threshold value.

In some embodiments, the media application may modify the attentiveness level threshold based on a user profile and/or a current status of the user. For example, a user may adjust the status to that of allowing interruptions from not allowing interruptions. When the status is set to not allowing interruptions, the attentiveness level threshold may be set to an infinite value or very high value in order to prevent messages from being presented when the user is not completely engaged with the user device (e.g., has a very low attentiveness level with the user device). Such a status may be desirable when the user is in a meeting or involved in an important activity in which the user does not want to be disturbed by messages or by the user device in general. Alternatively, when the status is set to allowing interruptions, the attentiveness level threshold may be set to zero or very low value in order to allow messages to be presented and disrupt the user even though the user is not completely engaged with the user device (e.g., has a very low attentiveness level with the user device). The attentiveness level threshold may be automatically adjusted by the media application based on a user profile (e.g., a calendar of the user) indicating what the current state or activity is of the user. For example, based on the user profile, the media application may determine the user is in a meeting or is in some state in which he does not want to be disturbed. In response, the media application may automatically modify the attentiveness level threshold to be a very high value to avoid disrupting the user at that time. When the user exits the meeting or leaves the state of non-interruption, the media application may automatically modify the attentiveness level threshold back to the default level or a previously stored level allowing interruptions.

As used herein, a “viewing area” refers to a finite distance from a display device typically associated with an area in which a user may be capable of viewing a message on the display device of the user device. In some embodiments, the size of the viewing area may vary depending on the particular display device. For example, a display device with a large screen size may have a greater viewing area than a display device with a small screen size. In some embodiments, the viewing area may correspond to the range of the detection modules associated with the media application. For example, if the detection module can detect a user only within five feet of a display device, the viewing area associated with the display device may be only five feet. Various systems and methods for detecting users within a range of a media device, are discussed in, for example, Shimy et al., U.S. patent application Ser. No. 12/565,486, filed Sep. 23, 2009, which is hereby incorporated by reference herein in its entirety.

As used herein, the term “message” refers to any type of communication that is to be presented to a user (visually or audibly) at a predetermined time or upon occurrence of an event. The event may be display of specified content (e.g., a commercial or content matching a user profile) on a display device, the actual receipt of the message from a remote source by the user device (e.g., receipt of an SMS message), and/or the receipt of the message by the remote source from another user device (e.g., a posting received by a social network server from another user). For example, the message may be any one or combination of a reminder for a media asset, a reminder to perform a task, an SMS message, an MMS message, an incoming e-mail message, an instant message, posting on a social network, a calendar reminder, a news alert, a sporting event alert, a traffic alert, any alert or banner provided to a user on a user device, and/or an alarm. The message may be locally stored (e.g., a reminder) or received from a remote source (e.g., SMS message). The remote source may be another user device or may be a content source or media data source.

In some embodiments, the message may be associated with an importance level. The importance level may be manually set by the user who generated the message (e.g., a user may set an importance level from level 1 to level 3, where level 3 is most important, for a content reminder or reminder to perform a task). Alternatively or in addition, the importance may be set automatically based on a user profile. For example, the user profile may indicate that the user always views one type of message (e.g., social network posting) and less frequently views another type of message (e.g., media asset reminder). Also, the user profile may be adjusted by the user to always assign messages of a given type (e.g., news alerts) a higher importance level than messages of another type (e.g., SMS messages). Accordingly, the media application may automatically associate a first message (e.g., a media asset reminder) with a lower importance level than a second message (e.g., social network posting). The importance level may be set by the provider of the message. For example, a news service may associate a breaking news type of news alert with a higher importance level than another less important type of news alert.

As used herein, the term “delay” refers to postponing display of a message until another time (e.g., because an attentiveness level of the user is below a threshold). Messages may be delayed by being locally or remotely stored in a memory or storage device such as a stack or queue. In some embodiments, messages may be delayed by rescheduling presentation of the messages for a predefined or user defined period of time. When the period of time is reached another determination may be made as to whether the user attentiveness level exceeds a threshold. If at that time the attentiveness level does not exceed the threshold, the message may be further delayed. Any other form of delaying may be used without departing from the scope of the disclosure.

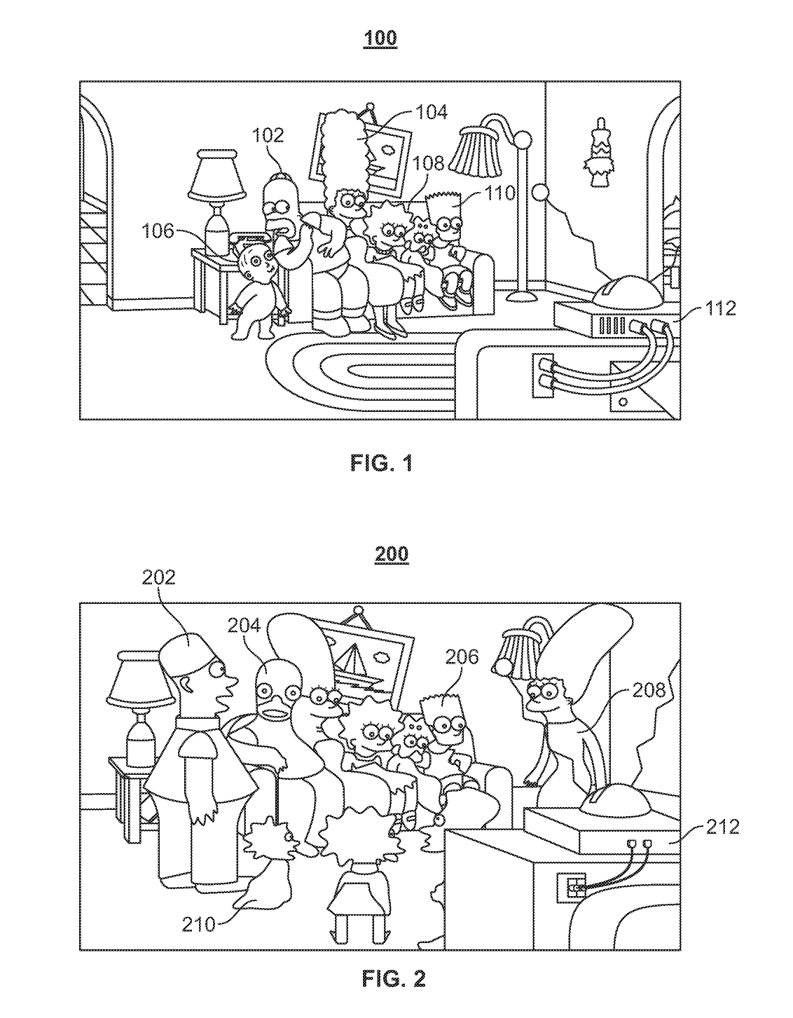

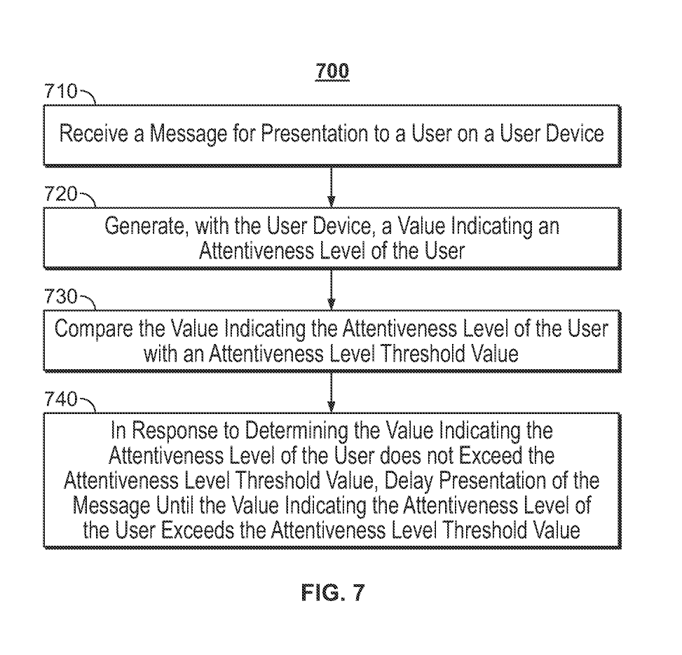

FIG. 1 shows an illustrative example of a viewing area from which a media application may determine an attentiveness level associated with each user in accordance with some embodiments of the disclosure. Viewing area 100 illustrates a viewing area featuring a plurality of users (e.g., user 102, user 104, user 106, user 108, and user 110) that a media application may analyze to determine whether or not to delay presentation of a received message on a display device (e.g., display device 112) of a user device as discussed in relation to FIGS. 7-9 below.

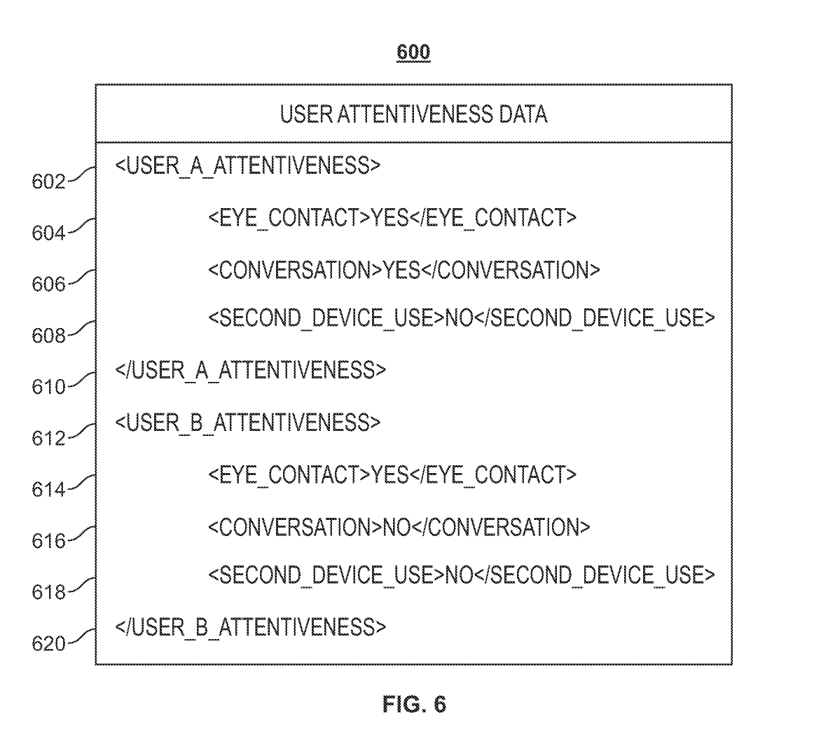

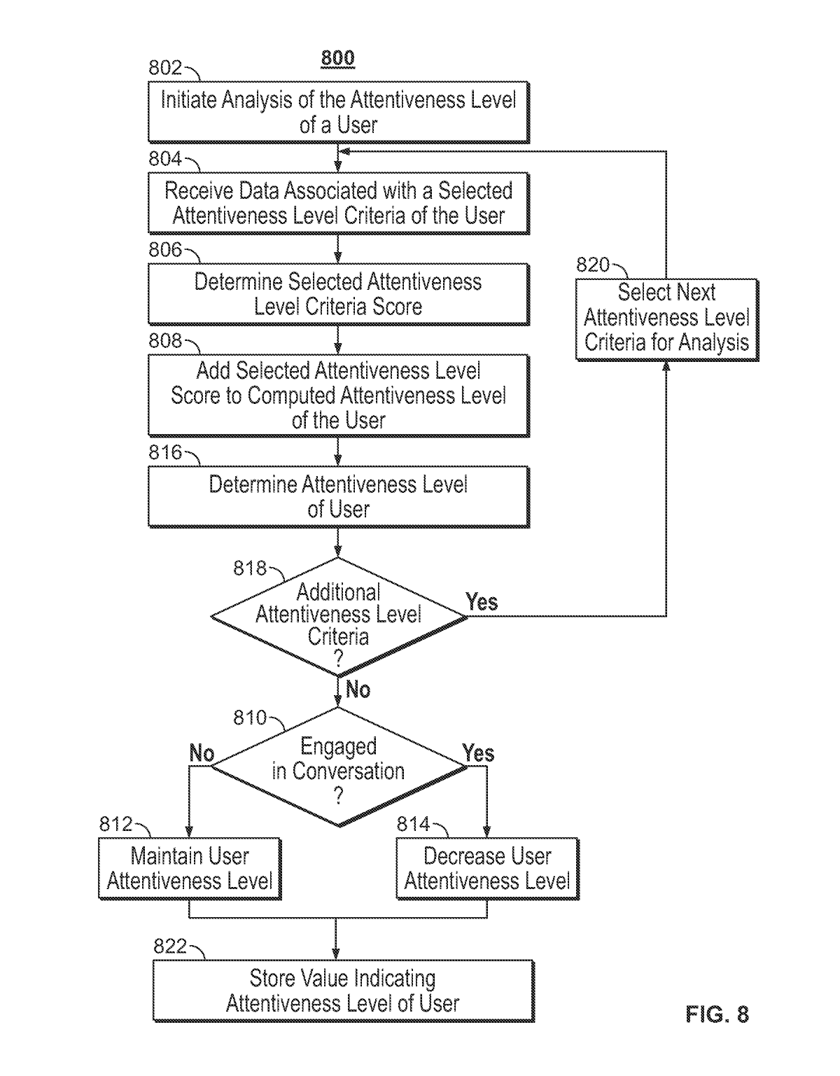

In some embodiments, a media application (e.g., implemented on display device 112) may determine the attentiveness level of each of the plurality of users in viewing area 100. Based on the characteristics and actions (e.g., whether or not the users are distracted from seeing the message on a display device of the user device) of each of the users, the media application determines an attentiveness level for each of the users (e.g., as described below in FIG. 6). In some embodiments, the attentiveness level for each user in viewing area 100 may be combined to generate a composite attentiveness level as described in FIG. 8 below.

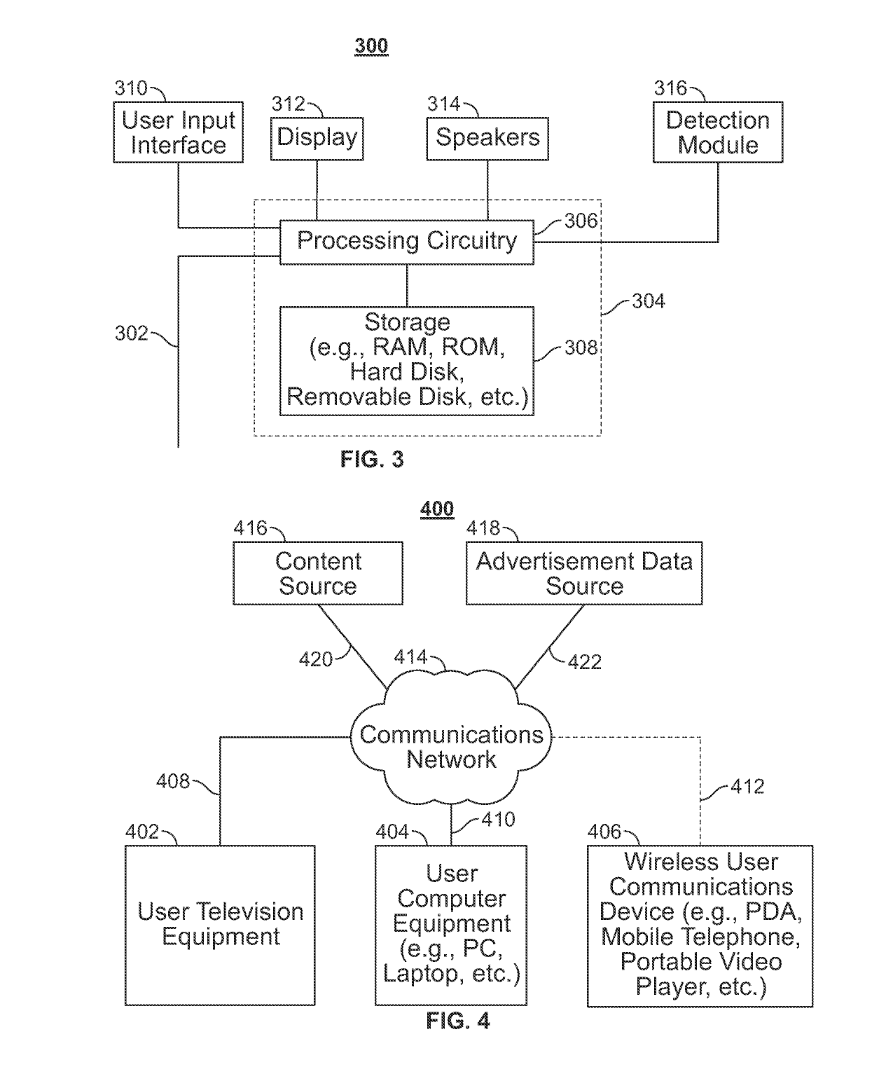

In viewing area 100, a plurality of users are currently viewing a media asset displayed on display device 112 (e.g., user equipment device 402, 404, and/or 406 (FIG. 4)). In order to determine whether or not to present a message, the media application may generate data associated with the attentiveness of each of the users (e.g., user 102, user 104, user 106, user 108, and user 110) via a detection module (e.g., detection module 316 (FIG. 3)) incorporated into, or accessible by, the media application. In some embodiments, the detection module may include multiple components capable of generating data, of various types, indicating the attentiveness level of each user.

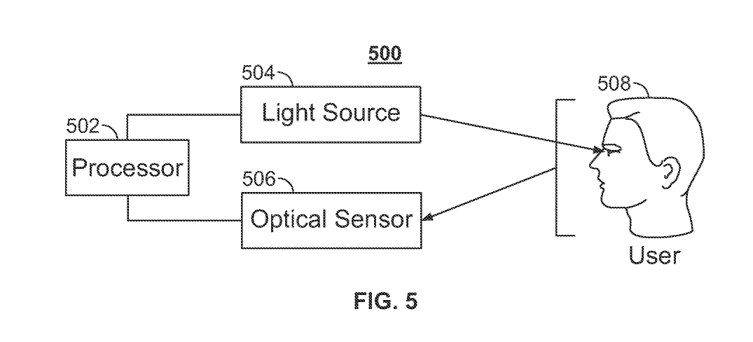

For example, a video detection component may detect the number of users and identity (e.g., in order to associate each user with a user profile as discussed above) of each of the users within viewing area 100, an audio detection module may determine user 102 and user 106 are currently engaged in a conversation, and an eye contact detection component (e.g., as described in FIG. 5 below) may determine that each of the users is currently making eye contact with display device 112. Based on this data, the media application may determine an attentiveness level for each of the users (e.g., as discussed below in relation to FIG. 7).

For example, when computing an attentiveness level for each of the users (e.g., as discussed in FIG. 8 below), the media application may increase the determined attentiveness level for each user because each user is currently making eye contact with the display device featuring the media asset. In addition, the media application may decrease the attentiveness level of user 102 and user 106 because they are currently engaged in a conversation.

For example, viewing area 100 may represent a group of users (e.g., user 102, user 104, user 106, user 108, and user 110) viewing an important event (e.g., the National Football League's Superbowl) on a display device (e.g., display device 112). Due to the importance of a message, the media application may want assurance that the message will be presented only when a threshold number of users or when the users have a threshold attentiveness level. Therefore, upon detecting a need to present a message (e.g., upon receipt of the message), the media application may retrieve an attentiveness threshold value from memory or from the message itself and compare that value to the attentiveness level of one or more users (e.g., as described in relation to FIGS. 7-9 below). Upon determining that the current attentiveness level of the users or the current number of users within the viewing area equals or exceeds the threshold value, the media application may issue (e.g., via control circuitry 304 (FIG. 3)) an instruction to present the message to the display device. Upon determining that the current attentiveness level of the users or the current number of users within the viewing area is below the threshold value, the media application may issue (e.g., via control circuitry 304 (FIG. 3)) an instruction to a storage device to add the message to a queue in order to delay presentation of the message until the attentiveness level of the users or the current number of users within the viewing area exceeds the threshold value.

It should be noted that the embodiments of this disclosure are not limited to any particular display device (e.g., a television) or any particular location (e.g., a private residence) of a display device. In some embodiments, the methods and systems of this disclosure may be adapted for use with various types of display devices and locations.

FIG. 2 shows another illustrative example of a viewing area from which the media application may determine an attentiveness level associated with each user in accordance with some embodiments of the disclosure. Viewing area 200 illustrates another viewing area featuring another plurality of users (e.g., user 202, user 204, user 206, user 208, and user 210) that a media application may analyze to determine whether or not to delay presentation of a message on a display device (e.g., display device 212) as discussed in relation to FIGS. 7-9 below.

In viewing area 200, not all users are currently viewing a media asset displayed on display device 212 (e.g., user equipment device 402, 404, and/or 406 (FIG. 4)). For example, user 202, user 204, user 206, user 208, and user 210 are not currently looking at display device 212. Therefore, in some embodiments, the media application may compute a lower attentiveness level for each of those users. For example, a detection module (e.g., detection module 316 (FIG. 3)) may determine that user 202, user 204, user 206, user 208, and user 210 are not currently making eye contact with the display device and are thus not viewing the media asset and/or messages. Therefore, when computing an attentiveness level for each of the users (e.g., as discussed in FIG. 8 below), the media application may decrease the determined attentiveness level for each user because each of those users is not currently making eye contact with the display device featuring the media asset.

In some embodiments, a message may not have been presented on a display because the attentiveness level of one or more users was too low. Therefore, the media guidance application may attempt to reschedule the presentation of the message. For example, the users (e.g., user 202, user 204, user 206, user 208, and user 210) in viewing area 200 may not have had the required attentiveness level for presentation of a message when the message was received. Therefore, the media guidance application (e.g., via control circuitry 304 (FIG. 3)) may record (e.g., in a local database such as storage 308 (FIG. 3) or in a remote database that the message was not presented.

The media guidance application may then hold the message in a queue until the media guidance application determines (e.g., via detection module 316 (FIG. 3)) that the attentiveness level of the users (e.g., user 202, user 204, user 206, user 208, and user 210) within the viewing area (e.g., viewing area 200) equals or exceeds (e.g., as discussed below in relation to FIG. 7) the threshold attentiveness level required for presenting the message.

FIG. 3 is a block diagram of an illustrative user equipment device in accordance with some embodiments of the disclosure. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media application stored in memory (i.e., storage 308). Specifically, control circuitry 304 may be instructed by the media application to perform the functions discussed above and below. For example, the media application may provide instructions to control circuitry 304 to generate the media guidance displays. In some implementations, any action performed by control circuitry 304 may be based on instructions received from the media application.

In client-server based embodiments, control circuitry 304 may include communications circuitry suitable for communicating with a media application server or other networks or servers. The instructions for carrying out the above mentioned functionality may be stored on the media application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and media application data, described above. Nonvolatile memory may also be used (e.g., to launch a boot-up routine and other instructions). Cloud-based storage, described in relation to FIG. 4, may be used to supplement storage 308 or instead of storage 308. Storage 308 may include a queue or stack used to store messages for which presentation has been delayed until an attentiveness level of one or more users is determined to exceed a threshold value.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive advertisement data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, etc.). In some embodiments, detection module 316 may include components that are specialized to generate particular information.

For example, as discussed below in relation to FIG. 5, detection module 316 may include an eye contact detection component, which determines or receives a location upon which one or both of a user's eyes are focused. The location upon which a user's eyes are focused is referred to herein as the user's “gaze point.” In some embodiments, the eye contact detection component may monitor one of both eyes of a user of user equipment 300 to identify a gaze point on display 312 for the user. The eye contact detection component may additionally or alternatively determine whether one or both eyes of the user are focused on display 312 (e.g., indicating that a user is viewing display 312) or focused on a location that is not on display 312 (e.g., indicating that a user is not viewing display 312). In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316 and may be a separate device or system in communication with user equipment device 300.

The media application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media application is a client-server based application. Data for use by a thick or thin client implemented on user equipment device 300 is retrieved on-demand by issuing requests to a server remote to the user equipment device 300. In one example of a client-server based media application, control circuitry 304 runs a web browser that interprets web pages provided by a remote server.

In some embodiments, the media application is downloaded and interpreted or otherwise run by an interpreter or virtual machine (run by control circuitry 304). In some embodiments, the media application may be encoded in the ETV Binary Interchange Format (EBIF), received by control circuitry 304 as part of a suitable feed, and interpreted by a user agent running on control circuitry 304. For example, the media application may be an EBIF application. In some embodiments, the media application may be defined by a series of JAVA-based files that are received and run by a local virtual machine or other suitable middleware executed by control circuitry 304. In some of such embodiments (e.g., those employing MPEG-2 or other digital media encoding schemes), the media application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled, allowing for access to Internet content, while user computer equipment 404 may, like some television equipment 402, include a tuner allowing for access to television programming. The media application may have the same layout on various different types of user equipment or may be tailored to the display capabilities of the user equipment. For example, on user computer equipment 404, the media application may be provided as a website accessed by a web browser. In another example, the media application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media application settings across in-home devices and remote devices. Settings include those described herein, as well as channel and program favorites, programming preferences that the media application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the media application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11×, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and advertisement data source 418 coupled to communications network 414 via communication paths 420 and 422, respectively. Paths 420 and 422 may include any of the communication paths described above in connection with paths 408, 410, and 412. Communications with the content source 416 and advertisement data source 418 may be exchanged over one or more communications paths, but are shown as a single path in FIG. 4 to avoid overcomplicating the drawing. In addition, there may be more than one of each of content source 416 and advertisement data source 418, but only one of each is shown in FIG. 4 to avoid overcomplicating the drawing. (The different types of each of these sources are discussed below.) If desired, content source 416 and advertisement data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Advertisement data source 418 may provide advertisement data, such as the advertisement rules associated with an advertisement. Data necessary for the functioning of the media application may be provided to the user equipment devices using any suitable approach. In some embodiments, the media application may be a stand-alone interactive television program guide that receives program guide data via a data feed (e.g., a continuous feed or trickle feed). Program schedule data and other advertisement data may be provided to the user equipment on a television channel sideband, using an in-band digital signal, using an out-of-band digital signal, or by any other suitable data transmission technique. Program schedule data and other advertisement data may be provided to user equipment on multiple analog or digital television channels.

In some embodiments, advertisement data from advertisement data source 418 may be provided to users' equipment using a client-server approach. For example, a user equipment device may pull advertisement data from a server, or a server may push advertisement data to a user equipment device. In some embodiments, a media application client residing on the user's equipment may initiate sessions with source 418 to obtain advertisement data when needed, e.g., when the advertisement data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Advertisement data source 418 may provide user equipment devices 402, 404, and 406 the media application itself or software updates for the media application.

Media applications may be, for example, stand-alone applications implemented on user equipment devices. For example, the media application may be implemented as software or a set of executable instructions which may be stored in storage 308, and executed by control circuitry 304 of a user equipment device 300. In some embodiments, media applications may be client-server applications where only a client application resides on the user equipment device, and server application resides on a remote server. For example, media applications may be implemented partially as a client application on control circuitry 304 of user equipment device 300 and partially on a remote server as a server application (e.g., advertisement data source 418) running on control circuitry of the remote server. When executed by control circuitry of the remote server (such as advertisement data source 418), the media application may instruct the control circuitry to generate the media application displays and transmit the generated displays to the user equipment devices. The server application may instruct the control circuitry of the advertisement data source 418 to transmit data for storage on the user equipment. The client application may instruct control circuitry of the receiving user equipment to generate the media application displays.

Content and/or advertisement data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may transfer only IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide advertisement data described above. In addition to content and/or advertisement data, providers of OTT content can distribute media applications (e.g., web-based applications or cloud-based applications), or the content can be displayed by media applications stored on the user equipment device.

Media guidance system 400 is intended to illustrate a number of approaches, or network configurations, by which user equipment devices and sources of content and advertisement data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media application implemented on a remote device. For example, users may access an online media application on a website via personal computers at their offices, or mobile devices such as a PDA or web-enabled mobile telephone. The user may set various settings (e.g., recordings, reminders, or other settings) on the online media application to control the user's in-home equipment. The online guide may control the user's equipment directly, or by communicating with a media application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media application to communicate directly with content source 416 to access content. Specifically, within a home, users of user television equipment 402 and user computer equipment 404 may access the media application to navigate among and locate desirable content. Users may also access the media application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more advertisement data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

The media application may incorporate, or have access to, one or more content capture devices or application, such as camcorders, digital cameras with video mode, audio recorders, mobile phones, and handheld computing devices, to generate data describing the attentiveness level of a user. The user can upload data describing the attentiveness level of a user to a content storage service on the cloud either directly, for example, from user computer equipment 404 or wireless user communications device 406 having a content capture feature. Alternatively, the user can first transfer the content to a user equipment device, such as user computer equipment 404. The user equipment device storing the data describing the attentiveness level of a user uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 is an illustrative example of one component of a detection module, which may be accessed by a media application in accordance with some embodiments of the disclosure. FIG. 5 shows eye contact detection component 500, which may be used to identify an attentiveness level criteria or criterion (e.g., the gaze point of a user of user equipment 300), in order to determine the attentiveness level of the user. Attentiveness level criteria may include any one or combination of user eye contact with a user device, a gaze point of a user, whether a user is engaged in a conversation with another user, whether a user is interacting with another device (e.g., a second screen device), whether the user is listening to the user device, and/or whether the user is within a perceivable range of a user device. A first device for measuring an attentiveness level criterion may include eye contact detection component 500 which includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye contact detection component 500 is configured for determining a gaze point of a single user. In other embodiments, eye contact detection component 500 may determine gaze points for a plurality of users (e.g., user 102, user 104, user 106, user 108, and user 110 (FIG. 1)). Eye contact detection component 500 may identify multiple users of user equipment device 300.

Processor 502 may be integrated with one or more light sources 504 and one or more optical sensors 506 in a single device. Additionally or alternatively, one or more light sources 504 and one or more optical sensors 506 may be housed separately from processor 502 and in wireless or wired communication with processor 502. One or more of processors 502, light sources 504, and optical sensors 506 may be integrated into user equipment device 300.

Processor 502 may be similar to processing circuitry 306 described above. In some embodiments, processor 502 may be processing circuitry 306, with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e. a first Purkinje image), the reflection from the inner surface of the cornea (i.e. a second Purkinje image), the reflection from the outer (anterior) surface of the lens (i.e. a third Purkinje image), and/or the reflection from the inner (posterior) surface of the lens (i.e. a fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e. corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to display 312. Using this information, processor 502 may determine a user's gaze point on display 312, or processor 502 may determine whether or not a user's gaze point is on display 312.

In some embodiments, eye contact detection component 500 performs best if the position of a user's head is fixed or relatively stable. In other embodiments, eye contact detection component 500 is configured to account for a user's head movement, which allows the user a more natural viewing experience than if the user's head were fixed in a particular position.

In some embodiments accounting for a user's head movement, eye contact detection component 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, user equipment device 300 may include two cameras used as optical sensors 506, or eye contact detection component 500 in communication with user equipment device 300 may include two optical sensors 506. In other embodiments, each of user equipment device 300 and eye contact detection component 500 may include an optical sensor, and processor 502 receives image data from the optical sensor of user equipment device 300 and the optical sensor of eye contact detection component 500.

Processor 502 may receive data identifying the location of optical sensor 506 relative to display 312 and/or relative to each other and use this information when determining the gaze point.

In other embodiments accounting for a user's head movement, eye contact detection component 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to display 312 and/or relative to each other and use this information when determining the gaze point.

In some embodiments, other types of eye contact detection components that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 500.

It should be noted that eye contact detection component 500 is but one type of component that may be incorporated into or accessible by detection module 316 (FIG. 3) or the media application for measuring an attentiveness level of a user or users. Other types of components, which may generate other types of data indicating an attentiveness level of a user or providing attentiveness level criteria or criterion (e.g., video, audio, textual, etc.) are fully within the bounds of this disclosure.

FIG. 6 is an illustrative example of a data structure that may be used to transmit data generated by the media application that is associated with an attentiveness level of a user in accordance with some embodiments of the disclosure. For example, data structure 600 may represent data generated by one or more components of detection module 316 (FIG. 3) such as eye contact detection component 500 (FIG. 5). In some embodiments, the media application may process data structure 600 to determine whether or not to delay presentation of a message as discussed below in relation to FIG. 7. For example, data structure 600 may be processed by control circuitry 304 (FIG. 3) as instructed by a media application implemented on user equipment 402, 404, and/or 406 (FIG. 4), content source 416 (FIG. 4), and/or any device accessible by communications network 414 (FIG. 4).

Data structure 600 includes multiple fields, which, in some embodiments, may include one of more lines of code for describing data and issuing instructions. For example, fields 602 through 620 indicate to the media application that data structure 600 relates to a media asset. It should be noted that the data (e.g., represented by the various fields) in data structure 600 is not limiting, and in some embodiments, the data as described in data structure 600 may be replaced or supplemented by other data as discussed in the disclosure.

Fields 602 through 610 relate to data describing the attentiveness level of a first user (e.g., user 102 (FIG. 1)) as generated by the media application, for example, via a detection module (e.g., detection module 316 (FIG. 3)) within a viewing area (e.g., viewing area 100 (FIG. 1)) associated with a display device (e.g., display device 112 (FIG. 1)). In some implementations, each of fields 602-610 may correspond to a different attentiveness level criteria or criterion. For example, field 604 indicates to the media application that the first user (e.g., user 102 (FIG. 1)) is making eye contact with the display device (e.g., display device 112 (FIG. 1)) displaying a media asset. Field 606 indicates to the media application that the first user is currently engaged in a conversation with another user (e.g., user 106 (FIG. 1)). Field 608 indicates to the media application that the first user is not using a second device (e.g., a smartphone or tablet computer).

Fields 612 through 620 relate to data describing the attentiveness level of a second user (e.g., user 104 (FIG. 1)) generated by the media application, for example, via a detection module (e.g., detection module 316 (FIG. 3)) within a viewing area (e.g., viewing area 100 (FIG. 1)). For example, field 614 indicates to the media application that the second user is making eye contact with the display device (e.g., display device 112 (FIG. 1)) displaying a media asset. Field 606 indicates to the media application that the second user is not currently engaged in a conversation with another user. Field 618 indicates to the media application that the second user is not currently using a second device.

The media application may use the information in data structure 600 to compute an attentiveness level associated with each user (e.g., as described in relation to FIG. 7). For example, the media application may increase the attentiveness level of the first user and second user upon determining (e.g., based on field 604 and field 608) that the first user is making eye contact with the display device (e.g., display device 112 (FIG. 1)) and not using a second device. The media application may also decrease the attentiveness level of the first user upon determining (e.g., based on field 606) that the user is currently engaged in a conversation with another user. Furthermore, the media application may determine that the attentiveness level of the second user is higher than the attentiveness level of the first user because the second user (e.g., as indicated by field 616) is not currently engaged in a conversation with another user.

FIG. 7 is a flowchart of illustrative steps for delaying presentation of a message based on user attentiveness level in accordance with some embodiments of the disclosure. Process 700 may be used to determine whether or not to delay presentation of a message (e.g., on display device 112 (FIG. 1)) based on the attentiveness level of one or more users. It should be noted that process 700 or any step thereof could be provided by any of the devices shown in FIGS. 3-4. For example, process 700 may be executed by control circuitry 304 (FIG. 3) as instructed by the media application.

At step 710, a message is received (e.g., by the media application) for presentation to a user on a user device (e.g., equipment 300). For example, control circuitry 304 may receive a message from a remote source (e.g., an SMS message). The received message may require immediate display to the user on user equipment device 300. In some implementations, the message may be a news alert or social network posting that control circuitry 304 receives and is instructed according to the message to present the message on a user device (e.g., a mobile phone or tablet). In some implementations, the message may be a reminder or calendar alert set by a user to be triggered at a certain time. The receipt of the message may occur when the system clock determines that the time for presenting the reminder or calendar alert has arrived and instructs control circuitry 304 to present the message to the user.

At step 720, the media application generates a value indicating an attentiveness level of a user relative to user equipment device 300 (e.g., the equipment device on which the received message is to be presented). For example, the media application may use a detection module (e.g., detection module 316 (FIG. 3)), which may be incorporated into or accessible by one or more content capture devices. Data captured by the content capture devices may be processed via a content recognition module or algorithm to generate data or a value (e.g., regarding whether or not the user is making eye contact with the display device or regarding an attentiveness level criteria or criterion) describing the attentiveness of a user. In some embodiments, the data describing the attentiveness of a user may be recorded in a data structure (e.g., data structure 600 (FIG. 6)), which may be transmitted from the detection module to the media application. The process for generating the value indicating an attentiveness level of one or more users is discussed in more detail below in connection with FIG. 8.

Additionally or alternatively, the media application may cross-reference the generated raw attentiveness level data in a database indicative of an attentiveness level of a user in order to determine an attentiveness level to associate with the user. For example, the media application may generate a data structure (e.g., data structure 600 (FIG. 6)) describing the attentiveness of a user. The data structure may then be transmitted to a remote server (e.g., advertisement data source 418 (FIG. 4)) to be cross-referenced in a database. Based on the cross-reference, the remote server may transmit an attentiveness level to associate with the user to the media application.

At step 730, the media application compares the value indicating the attentiveness level of the user with a threshold attentiveness level value. The media application may retrieve from storage 308 a threshold value for attentiveness level. In some implementations, the received message may be associated with a given threshold value that may be different from a default or previously stored threshold value. The computed attentiveness level value may represent a numerical amount or score and may be compared with the retrieved threshold value. The media application (e.g., via control circuitry 304 (FIG. 4)) may then determine whether or not the attentiveness level value of the user (e.g., user 102 (FIG. 1)) equals or exceeds the threshold attentiveness level value.

If the media application determines that the attentiveness level exceeds the threshold attentiveness level, the media application (e.g., via control circuitry 304 (FIG. 3)) may transmit an instruction to present the message on the display device (e.g., display device 112 (FIG. 1)). At step 740, in response to determining that the value indicating the attentiveness level of the user does not exceed the attentiveness level threshold value, the media application (e.g., via control circuitry 304 (FIG. 3)) may transmit an instruction to storage 308 to delay presentation of the received message. For example, the media application may add the received message to a stack or queue for presentation when the attentiveness level of the user is determined to exceed the threshold value.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps for computing a value indicating an attentiveness level of one or more users in accordance with some embodiments of the disclosure. Process 800 may be used to determine whether or not to delay presentation of a message based on the attentiveness level of one or more users. It should be noted that process 800 or any step thereof could be provided by any of the devices shown in FIGS. 3-4. For example, process 800 may be executed by control circuitry 304 (FIG. 3) as instructed by the media application.

At step 802, the media application initiates an analysis of the attentiveness of a user. In some embodiments, the media application may issue an instruction (e.g., via control circuitry 304 (FIG. 3)) to a detection module (e.g., detection module 316 (FIG. 316)) to generate data describing the attentiveness level of one or more users (e.g., user 102 (FIG. 1)) in a viewing area (e.g., viewing area 100 (FIG. 1)) of a user equipment device 300 on which a message is to be presented.

For example, in response to receiving an instruction from the media application, a detection module (e.g., detection module 316 (FIG. 3)) may instruct one or more of its components to generate one or more types of data. For example, in response to an instruction from the media application (e.g. via control circuitry 304 (FIG. 3)) or the detection module, an eye contact detection component (e.g., eye contact detection component 500 (FIG. 5)) may generate data describing whether or not a user is making eye contact with the display device (e.g., display device 112 (FIG. 1)) on which a message is to be presented.

At step 804, the media application receives data associated with a selected attentiveness level criterion. For example, in some embodiments, data associated with a selected attentiveness level criterion of a user may be recorded/transmitted in a data structure (e.g., data structure 600 (FIG. 6)). In some embodiments, the data structure may be generated by the detection module (e.g., detection module 316 (FIG. 3)) from transmission to the media application. For example, the selected attentiveness level criterion may be an indication of whether the user is gazing towards the display on which the message is to be presented.

At step 806, the media application (e.g., via control circuitry 304 (FIG. 3)) determines a score for the selected attentiveness level based on the data associated with the selected attentiveness level criterion. For example, when the selected attentiveness level criterion is an indication of whether the user is gazing towards the display on which the message is to be presented, the media application may assign a value to the selected criterion equal to one point if the user is currently making eye contact and negative one point if the user is not currently making eye contact with the display.

At step 808, the media application adds the computed score of the selected attentiveness level criterion to the overall computed attentiveness level of the user. For example, in some embodiments, the media application may receive several types of data associated with the attentiveness of a user (e.g., from one or more components of detection module 316 (FIG. 3)) and individual scores/values may be assigned to each time of data. The media application may then add the scores/values of the different types of data to generate the overall attentiveness level associated with the user. In some implementations, an overall score that is very high may indicate that more than one or some other predetermined number of attentiveness level criterions have been met or indicate the user is attentive to the user device. In some implementations, an overall score that is very low may indicate that a fewer number of attentiveness level criterions have been met or indicate the user is attentive to the user device.

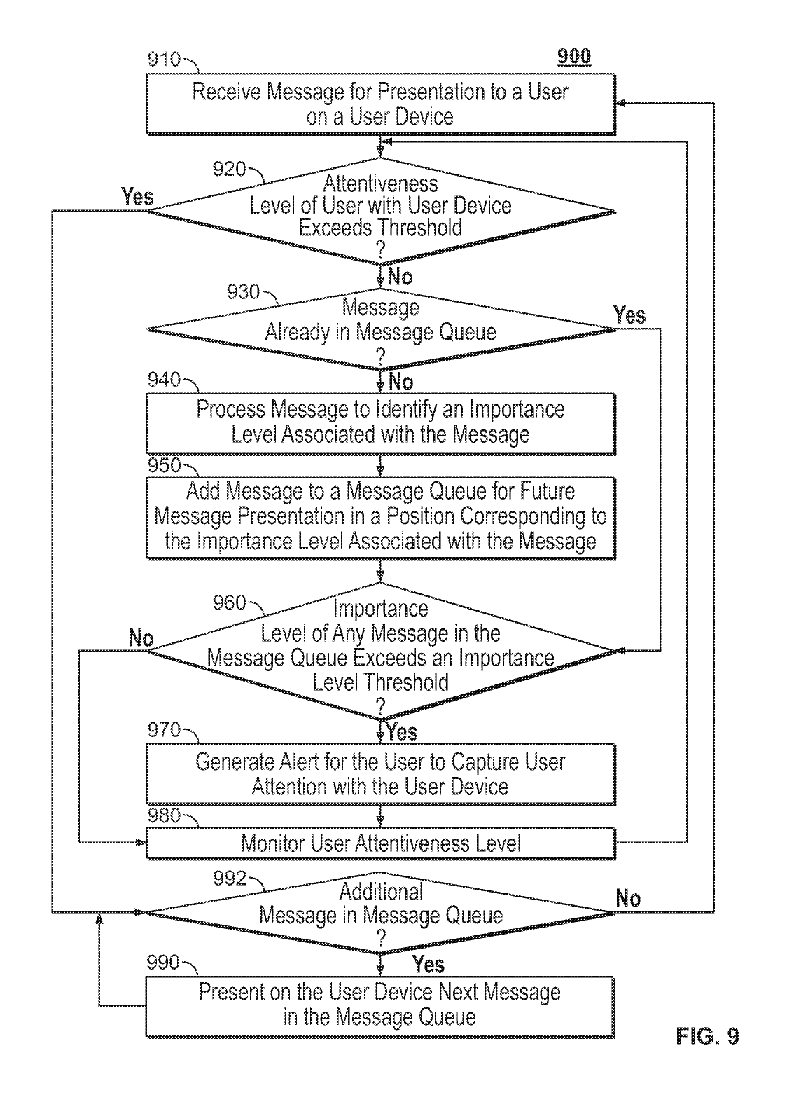

At step 816, the media application determines the attentiveness level of the user. For example, as discussed above, the media application may receive multiple types of data describing the attentiveness of the user. The media application (e.g., via control circuitry 304 (FIG. 3)) may process (e.g., via assigning a value and adding the values together) each type of data to determine an attentiveness level associated with the user. The attentiveness level of the user may then be used to determine whether or not to transmit an instruction to delay presentation of a message as discussed in relation to FIGS. 7 and 9.

At step 818, the media application determines whether or not there are additional attentiveness level criteria to process and add to the overall attentiveness level score. If so, the media application proceeds to step 820, to select a different attentiveness level criterion to process and add to the overall attentiveness level score, and returns to step 804. If the media application determines there are no additional attentiveness level criterions to process, the media application proceeds to step 810.

At step 810, the media application determines whether or not the user is currently engaged in a conversation. For example, the media application may receive data (e.g., generated using speech recognition techniques discussed above), which indicate that the user is speaking to another user. In some embodiments, the data may be transmitted in a data structure (e.g., data structure 600 (FIG. 6)), which indicates (e.g., field 606 (FIG. 6)) whether or not the user is engaged in a conversation. Data related to whether or not the user is currently engaged in conversation may then be used by the media application to determine an attentiveness level of the user.

If the media application determines (e.g., via processing data structure 600 (FIG. 6)) that the user is currently engaged in a conversation, the media application, at step 814, decreases (e.g., by an increment of value used to compute the attentiveness level of the user) the attentiveness level of the user because speaking to another user may distract the user from the message displayed on the display device (e.g., display device 112 (FIG. 1)). If the media application determines (e.g., via processing data structure 600 (FIG. 6)) that the user is not currently engaged in a conversation, the media application, at step 812, maintains the overall computed attentiveness level of the user because the user is less likely to be distracted from seeing the message displayed on the display device (e.g., display device 112 (FIG. 1)).

At step 822, the overall attentiveness level computed for the one or more users is stored in storage 308. The stored value may be compared at step 730 (FIG. 7) with the threshold value for the attentiveness level to determine whether or not to delay presentation of the message received.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

FIG. 9 is a flowchart of illustrative steps for determining whether or not to delay presentation of a received message in accordance with some embodiments of the present disclosure. For example, in some embodiments, process 900 may be used in parts of process 700 (FIG. 7). It should be noted that process 900 or any step thereof could be provided by any of the devices shown in FIGS. 3-4. For example, process 900 may be executed by control circuitry 304 (FIG. 3) as instructed by the media application.

At step 910, the media application may receive a message for presentation to a user on a user device. For example, control circuitry 304 may receive a message from a remote source (e.g., an SMS message). The received message may require immediate display to the user on user equipment device 300. In some implementations, the message may be a news alert or social network posting that control circuitry 304 receives and is instructed according to the message to present the message on a user device (e.g., a mobile phone or tablet). In some implementations, the message may be a reminder or calendar alert set by a user to be triggered at a certain time. The receipt of the message may occur when the system clock determines that the time for presenting the reminder or calendar alert has arrived and instructs control circuitry 304 to present the message to the user. Step 910 may be performed each time a new message is received by the user device (e.g., user equipment device 300).

At step 920, the media application may determine whether an attentiveness level value of the user with the user device exceeds a threshold. For example, the media application may instruct control circuitry 304 to determine an attentiveness level of the user (e.g., using process 800) and to retrieve from storage 308 an attentiveness level threshold value. In some implementations, control circuitry 304 may compute the attentiveness level threshold value based on a current state of the user or a profile associated with the user. The media application may compare the determined attentiveness level with the retrieved or computed attentiveness level threshold value to determine whether the threshold is exceeded. In response to determining that the threshold is exceeded, the process proceeds to step 990, otherwise the process proceeds to step 930.

At step 930, the media application may determine whether the received message is already stored in a message queue. For example, the media application may instruct control circuitry 304 to retrieve a unique identifier from the received message and process the entries stored in message queue stored in storage 308. Control circuitry 304 may process the entries stored in the message queue to determine whether any entry includes a unique identifier of a message that matches the unique identifier of the received message. In response to determining that one of the messages in the message queue is associated with a unique identifier that matches the unique identifier of the received message, control circuitry 304 may inform the media application that the received message is already in the message queue, otherwise control circuitry 304 may inform the media application that the received message is not already stored in the message queue. In response to determining that the received message is in the message queue, the media application may proceed to step 960, otherwise the process proceeds to step 940.

At step 940, the media application may process the received message to identify an importance level associated with the message. For example, the media application may process a data structure associated with the message to determine whether an importance field in the data structure includes a level of importance (e.g., a level from 1-3 where 1 is least important). In some implementations, the media application may automatically assign an importance level to the received message based on a user profile and the type of message that was received. For example, the user may have previously indicated or the media application may automatically determine based on monitored user interactions, that messages from a given news source (e.g., news alerts) are always viewed and therefore should be identified as a higher importance level than messages of another type (e.g., SMS messages). Similarly, the media application may determine based on the user profile that messages posted on a social network are associated with a higher importance level than messages received from a news source. The media application may automatically assign an importance level to the received message based on the type of message and the user profile.

Alternatively or additionally, the media application may process the contents of the message and perform text or content recognition to determine and assign an importance level of the message. For example, the media application may perform text recognition on the received message to determine whether certain words (stored in a database) associated with high importance level (e.g., “urgent,” “emergency,” and/or “important”) appear in the received message. In response to determining the content of the message includes words associated with a high importance level, the media application may assign a high importance level to the message. In some implementations, the media application may perform image recognition on the received message to determine whether certain images associated with high importance level (e.g., pictures of friends or family members or important people identified by the user) appear in the received message. In response to determining the content of the message includes images associated with a high importance level, the media application may assign a high importance level to the message.

At step 950, the media application may add the received message to a message queue for future presentation to a user in a position corresponding to the importance level associated with or assigned to the received message. For example, the media application may instruct control circuitry 304 to process the messages stored in the message queue and compare the importance level assigned to or associated with each message stored in the queue with the importance level assigned to or associated with the received message. In response to determining that the received message is associated with or is assigned a higher importance level than another message in the message queue, control circuitry 304 may be instructed by the media application to place the received message ahead of the message with the lower importance level. In response to determining that the received message is associated with or is assigned a lower importance level than another message in the message queue, control circuitry 304 may be instructed by the media application to place the received message behind of the message with the lower importance level. This way, messages with higher priorities than other messages in the queue and that are positioned ahead of the messages with the lower priorities will be retrieved from the queue for presentation to the user before the messages associated with the lower priorities.

At step 960, the media application may determine whether an importance level of any message in the message queue exceeds an importance level threshold. In response to determining that a message in the message queue has an importance level that exceeds the importance level threshold, the media application may proceed to step 970, otherwise the process proceeds to step 980. For example, the media application may retrieve from storage 308 an importance level threshold. The importance level threshold may be user defined or automatically determined by the media application. Specifically, the user may specify an importance level threshold that indicates to the media application that if a very important message is received, the user should be alerted regardless of the attentiveness level the user has relative to the user device. Alternatively or in addition, the media application may retrieve a profile associated with the user and compute automatically an importance level threshold based on a status of the user or the likes and dislikes of the user. In particular, if the media application determines that the user is driving or is in a meeting, the media application may automatically compute a very high importance level threshold as it is unlikely the user would like to be informed about messages that are not of the upmost importance (e.g., urgent or emergencies). Alternatively, if the media application determines that the user is having coffee with a friend, the media application may automatically compute a very low importance level threshold as it is likely the user would like to be informed about messages that are even of the slightest importance because it would not be too disturbing.

The media application may instruct control circuitry 304 to retrieve and compare the importance level of each message stored in the message queue with the importance level threshold value. In response to identifying that a message has an importance level that exceeds the importance level threshold value, control circuitry 304 may inform the media application about which message has an importance level that exceeds the threshold value. In response to receiving such an indication from control circuitry 304, the media application may proceed to step 970. In response to identifying that no message has an importance level that exceeds the importance level threshold value, control circuitry 304 may inform the media application and in response to the media application may proceed to step 980.

At step 970, the media application may generate an alert for the user to capture the user's attention with the user device. For example, the media application may instruct control circuitry 304 to modify the volume of the user device (e.g., raise the volume), generate an audible or visual alarm with the user device, toggle a visual flash, modify the brightness setting of the user device (e.g., continuously increase and decrease the brightness setting), and/or enable a physical alert such as a vibration mechanism on the user device.

At step 980, the media application may monitor a user attentiveness level. For example, the media application may perform process 800 to generate and update an overall attentiveness level of the user relative to the user device.

At step 990, the media application may present on the user device the next message that is in the message queue. For example, the media application may instruct control circuitry 304 to retrieve a message from the queue (e.g., the message positioned first in the queue, the message positioned last in the queue, and/or the message having the highest priority level of all other messages in the queue). Control circuitry 304 may display the retrieved message on a display device of the user device. For example, the message may be presented as an overlay on top of media being shown on the user device, the message may be presented in a full screen of the user device, the message may be provided over the speakers of the user device, and/or in any other suitable manner.

At step 992, the media application may determine whether there are additional messages in the message queue. In response to determining there are additional messages in the message queue, the media application may proceed to step 990, otherwise the process proceeds to step 910.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for presenting messages based on user engagement with a user device, the method comprising:
receiving a message for presentation to a user on the user device;
generating, with the user device, a value indicating an attentiveness level of the user;
comparing the value indicating the attentiveness level of the user with an attentiveness level threshold value; and
in response to determining the value indicating the attentiveness level of the user does not exceed the attentiveness level threshold value, delaying presentation of the message until the value indicating the attentiveness level of the user exceeds the attentiveness level threshold value.

2. The method of claim 1, wherein the value indicating the attentiveness level of the user represents at least one of whether or not the user is gazing towards the user device, whether the user is listening to the user device, whether the user is interacting with another user device, and whether the user is interacting with another user.

3. The method of claim 1, wherein generating the value comprises:
receiving data indicative of whether or not the user is engaged in a conversation with another user; and
in response to determining the user is engaged in a conversation with another user, decreasing the value indicating the attentiveness level of the user.

4. The method of claim 1, wherein generating the value comprises:
receiving data indicative of whether or not the user is interacting with another user device; and
in response to determining the user is interacting with the another user device, decreasing the value indicating the attentiveness level of the user.

5. The method of claim 1, wherein generating the value comprises:
receiving data indicative of whether or not the user is gazing towards the user device; and
in response to determining the user is gazing towards the user device, increasing the value indicating the attentiveness level of the user.

6. The method of claim 1, wherein the message includes at least one of a reminder for a media asset, an SMS message, an MMS message, an incoming e-mail message, a calendar reminder, a news alert, a sporting event alert, a traffic alert, and an alarm.

7. The method of claim 1, wherein delaying presentation comprises:
storing the received message in a memory of the user device;
monitoring the attentiveness level of the user to generate an updated value indicating the attentiveness level of the user;
comparing the updated value indicating the attentiveness level of the user with the attentiveness level threshold value;
in response to determining the updated value indicating the attentiveness level of the user does not exceed the attentiveness level threshold value, repeating the monitoring to generate the updated value and the comparing of the updated value; and
in response to determining the updated value indicating the attentiveness level of the user exceeds the attentiveness level threshold value, causing the stored received message to be presented on the user device.

8. The method of claim 1, wherein delaying presentation comprises:
processing the message to identify an importance level associated with the message;
determining whether the importance level of the message exceeds an importance level threshold value; and
in response to determining that the importance level of the message exceeds the importance level threshold value, triggering, with the user device, an audible or visual alert for the user to capture the attention of the user with the user device.

9. The method of claim 8, wherein triggering the audible or visual alert comprises:
monitoring the attentiveness level of the user to generate an updated value indicating the attentiveness level of the user;
comparing the updated value indicating the attentiveness level of the user with the attentiveness level threshold value;
in response to determining the updated value indicating the attentiveness level of the user does not exceed the attentiveness level threshold value:
increasing an audible or visual level associated with the alert; and
repeating the monitoring to generate the updated value and the comparing of the updated value; and
in response to determining the updated value indicating the attentiveness level of the user exceeds the attentiveness level threshold value, causing the received message to be presented on the user device.

10. The method of claim 1 further comprising:
processing the message to identify an importance level associated with the message; and
modifying the attentiveness level threshold value based on the importance level associated with the message, such that the attentiveness level threshold value is decreased when the importance level associated with the message is lower than an importance level threshold value.

11. A system for presenting messages based on user engagement with a user device, the system comprising:
control circuitry configured to:
receive a message for presentation to a user on the user device;
generate, with the user device, a value indicating an attentiveness level of the user;
compare the value indicating the attentiveness level of the user with an attentiveness level threshold value; and
in response to determining the value indicating the attentiveness level of the user does not exceed the attentiveness level threshold value, delay presentation of the message until the value indicating the attentiveness level of the user exceeds the attentiveness level threshold value.

12. The system of claim 11, wherein the value indicating the attentiveness level of the user represents at least one of whether or not the user is gazing towards the user device, whether the user is listening to the user device, whether the user is interacting with another user device, and whether the user is interacting with another user.

13. The system of claim 11, wherein the control circuitry is further configured to:
receive data indicative of whether or not the user is engaged in a conversation with another user; and
in response to determining the user is engaged in a conversation with another user, decrease the value indicating the attentiveness level of the user.

14. The system of claim 11, wherein the control circuitry is further configured to:
receive data indicative of whether or not the user is interacting with another user device; and
in response to determining the user is interacting with the another user device, decrease the value indicating the attentiveness level of the user.

15. The system of claim 11, wherein the control circuitry is further configured to:
receive data indicative of whether or not the user is gazing towards the user device; and
in response to determining the user is gazing towards the user device, increase the value indicating the attentiveness level of the user.

16. The system of claim 11, wherein the message includes at least one of a reminder for a media asset, an SMS message, an MMS message, an incoming e-mail message, a calendar reminder, a news alert, a sporting event alert, a traffic alert, and an alarm.

17. The system of claim 11, wherein the control circuitry is further configured to:
store the received message in a memory of the user device;
monitor the attentiveness level of the user to generate an updated value indicating the attentiveness level of the user;
compare the updated value indicating the attentiveness level of the user with the attentiveness level threshold value;
in response to determining the updated value indicating the attentiveness level of the user does not exceed the attentiveness level threshold value, repeat the monitoring to generate the updated value and the comparing of the updated value; and
in response to determining the updated value indicating the attentiveness level of the user exceeds the attentiveness level threshold value, cause the stored received message to be presented on the user device.

18. The system of claim 11, wherein the control circuitry is further configured to:
process the message to identify an importance level associated with the message;
determine whether the importance level of the message exceeds an importance level threshold value; and
in response to determining that the importance level of the message exceeds the importance level threshold value, trigger, with the user device, an audible or visual alert for the user to capture the attention of the user with the user device.

19. The system of claim 18, wherein the control circuitry is further configured to:
monitor the attentiveness level of the user to generate an updated value indicating the attentiveness level of the user;
compare the updated value indicating the attentiveness level of the user with the attentiveness level threshold value;
in response to determining the updated value indicating the attentiveness level of the user does not exceed the attentiveness level threshold value:
increase an audible or visual level associated with the alert; and
repeat the monitoring to generate the updated value and the comparing of the updated value; and
in response to determining the updated value indicating the attentiveness level of the user exceeds the attentiveness level threshold value, cause the received message to be presented on the user device.

20. The system of claim 11, wherein the control circuitry is further configured to:
process the message to identify an importance level associated with the message; and
modify the attentiveness level threshold value based on the importance level associated with the message, such that the attentiveness level threshold value is decreased when the importance level associated with the message is lower than an importance level threshold value.

21-30. (canceled)
